(19) United States
(12) Patent Application Publication
(10) Pub. No.: US 2014/0136696 A1
(43) Pub. Date: May 15, 2014

(54) Context Extraction

(71) Applicant: NOKIA CORPORATION, Espoo (FI)

(72) Inventors: Jussi Leppänen, Tampere (FI); Antti Eronen, Tampere (FI)

(73) Assignee: NOKIA CORPORATION, Espoo (FI)

(21) Appl. No.: 14/127,366

(22) PCT Filed: Jun. 28, 2011
(86) PCT No.: PCT/FI2011/050615

§ 371 Date: Dec. 18, 2013

(51) Int. Cl. H04L 12/26

(52) U.S. Cl. CPC H04L 43/0817
USPC 709/224

(57) ABSTRACT

There is disclosed a method comprising receiving identifier data relating to a communication network; examining a set of identifier data to identify number of different identifier data in the set of location data; on the basis of the examining determining a status of an apparatus; and if the examining indicates that the status of the apparatus is a first state, examining context data relating to the first state to determine the current context of the apparatus. There is also disclosed a computer program comprising computer-executable program code portions stored therein, comprising program code instructions for performing the method. There is further disclosed an apparatus comprising a processor and a memory including computer program code, the memory and the computer program code configured to, with the processor, cause the apparatus to performing the method.

### TECHNICAL FIELD

Various implementations relate generally to electronic communication device technology and, more particularly, relate to a method and apparatus for context extraction.

### BACKGROUND INFORMATION

Current and future networking technologies continue to facilitate ease of information transfer and convenience to users by expanding the capabilities of mobile electronic devices. One area in which there may be a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. Alternatively, the network device may respond to commands or requests made by the user (e.g., content searching, mapping or routing services, etc.). The services may be provided from a network server or other network device, or even from the mobile terminal such as, for example, a mobile telephone, a mobile navigation system, a mobile computer, a mobile television, a mobile gaming system, etc.

The ability to provide various services to users of mobile terminals can often be enhanced by tailoring services to particular situations or locations of the mobile terminals. Accordingly, various sensors have been incorporated into mobile terminals. Sensors typically gather information relating to a particular aspect of the context of a mobile terminal such as location, speed, orientation, and/or the like. The information from a plurality of sensors can then be used to determine device context, which may impact the services provided to the user.

Context is any information that can be used to predict the situation of an entity. The entity might be both the user and the device in an environment. Context awareness relates to a device's ability to be aware of its environment, user action and its own state and adapt its behavior based on the situation.

Context extraction algorithms may use various sensors to deduce the context of the user of a mobile phone. For example, the microphone of the mobile phone may be used to recognize the user's current environment (‘car’, ‘street’, ‘office’, etc.) or the accelerometer for recognizing the user's activity (‘running’, ‘walking’, etc.). Recording sensory data and the context recognition algorithms using the sensory data can, however, be very power demanding. The amount of power needed to run the algorithms may dictate how often the context extraction algorithms can be run. In the case of periodic or continuous sensing, high power consumption may mean that the algorithms will be run with longer intervals, which may limit their ability to react to context changes quickly.

It may be possible to collect information on which environments and activities the user is performing in certain locations and then combine locations with similar context histories together. Similar locations form clusters which have certain type of likelihood of certain environments and activities. For example, shops, restaurants, and streets are common environments in a city centre. The distribution of certain context labels in clusters may then be used to make context predictions.

### SUMMARY

A method, apparatus and computer program are therefore provided to enable context extraction.

According to a first aspect of the invention there is provided a method comprising:
receiving at least one identifier data relating to a communication network;
examining a set of identifier data to identify number of different identifier data in the set of identifier data;
on the basis of the examining determining a status of an apparatus; and
if the examining indicates that the status of the apparatus is in a first state, examining context data relating to the first state to determine a current context of the apparatus.

According to a second aspect of the invention there is provided an apparatus comprising a processor and a memory including computer program code, the memory and the computer program code configured to, with the processor, cause the apparatus:
to receive at least one identifier data relating to a communication network;
to examine a set of identifier data to identify number of different identifier data in the set of identifier data;
on the basis of the examining to determine a status of the apparatus; and
if the examining indicates that the status of the apparatus is a first state, to examine context data relating to the first state to determine a current context of the apparatus.

According to a third aspect of the invention there is provided a computer program comprising program instructions for:
receiving at least one identifier data relating to a communication network;
examining a set of identifier data to identify number of different identifier data in the set of identifier data;
on the basis of the examining determining a status of an apparatus; and
if the examining indicates that the status of the apparatus is a first state, examining context data relating to the first state to determine a current context of the apparatus.

According to a fourth aspect of the invention there is provided an apparatus comprising:
an input adapted to receive at least one identifier data relating to a communication network;
a first examining element adapted to examine a set of identifier data to identify number of different identifier data in the set of identifier data;
a determinator adapted to determine a status of the apparatus on the basis of the examining; and
a second examining element adapted to examine context data relating to the first state to determine a current context of the apparatus, if the examining indicates that the status of the apparatus is a first state.

According to a fifth aspect of the invention there is provided an apparatus comprising:
means for receiving at least one identifier data relating to a communication network;
means for examining a set of identifier data to identify number of different identifier data in the set of identifier data;
means for determining a status of the apparatus on the basis of the examining; and
means for examining context data relating to the first state to determine a current context of the apparatus, if the examining indicates that the status of the apparatus is a first state.

An advantage of using the context extraction according to some example embodiments of the present invention is that power savings can be achieved. It may be possible to get an approximation of the environment or activity likelihoods using very little processing and energy. One reason for this is that the device may anyway be connected to a nearby access point (e.g. a base station of a wireless communication network) and obtaining the cell-id thus may cause zero or very little extra power consumption. Minimal calculations are needed to obtain the cell-id and lookup the associated histogram for the location, whereas running the sensors (e.g. audio, accelerometer) may consume significantly power.

### DESCRIPTION OF THE DRAWINGS

In the following various embodiments will be disclosed in more detail with reference to the accompanying drawings, which are not necessarily drawn to scale, and wherein:

FIG. 1 is a schematic block diagram of a mobile terminal that may employ an example embodiment;

FIG. 2 is a schematic block diagram of a wireless communications system according to an example embodiment;

FIG. 3 illustrates a block diagram of an apparatus for providing context determination according to an example embodiment;

FIG. 4 illustrates an example situation when a user moves from a location A to a location B;

FIG. 5a illustrates an implementation architecture for providing context determination and context extraction according to an example embodiment;

FIG. 5b illustrates another implementation architecture for providing context determination and context extraction according to an example embodiment;

FIGS. 6a-6g

illustrate an example sequence of detected cell-ids by the device according to an example embodiment;

FIG. 7a illustrates an example of determining whether a ‘in motion’ is a known motion or an unknown motion;

FIG. 7b illustrates another example of determining whether a ‘in motion’ is a known movement or an unknown movement;

FIG. 8a depicts an example of how the environment determination and histogram adaptation works according to an example embodiment;

FIG. 8b depicts an example of how the low-power mode of environment determination works according to an example embodiment;

FIG. 9a illustrates a conceptual flow diagram of the context determination process in a first mode of operation provided by an example embodiment; and

FIG. 9b illustrates a conceptual flow diagram of the distributed context determination process in a second mode of operation provided by an example embodiment.

### DETAILED DESCRIPTION OF SOME EXAMPLE EMBODIMENTS

Some embodiments of a method, apparatus and computer program may enable a low-power implementation to context sensing. In some embodiments, it may be determined, from identity information relating to an access point of a communication network (e.g. a cell-id) and accelerometer information, whether the user's apparatus is ‘in motion’ or ‘static’. When the user is determined to be ‘in motion’ the user may be moving from one location to another location. In other words, the context may first be ‘static’, while the user is moving the context may be detected to be ‘in motion’, and when the user has arrived the other place, the context may return to ‘static’. Also if the user is determined to be ‘static’, it can be determined whether the user has been in the same location before. For the different ‘static locations’ the user visits, a histogram of environments and activities may be collected. After collecting some data for a ‘static location’, the histogram may be used to provide a guess of the environment and activity of the user without running the environment and activity recognizers and the device sensors (e.g. audio, accelerometer). This may significantly save power. Alternatively, the recognizers can be run at longer intervals when the current ‘static location’ is well known and at higher frequencies when the ‘static location’ has not been visited often.

In addition to storing histograms for different ‘static locations’, it is also possible to store similar histograms for different ‘movements’ that happen between ‘static locations’.

Some embodiments will now be described more fully hereinafter with reference to the accompanying drawings, in which some, but not all embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments. Thus, use of any such terms should not be taken to limit the spirit and scope of various embodiments. The term “set” may be used to describe a collection of one or more elements. For example, a set of identifier data may contain one or more identifier data elements.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Some embodiments may be used to perform context sensing and extraction more efficiently. Since onboard sensors of hand-held devices (e.g., mobile terminals) may use lots of power while performing context sensing it may be beneficial to reduce the operation time of these sensors. On the other hand, a hand-held device having communication capabilities with a communication network may be operating and collecting location based data from the communication network although the user is not actively using the device. For example, the user may sit at his work desk in an office wherein the context remains the same. Therefore, it may not be necessary to utilize all or any of the sensors and they can be switched off or set to a low-power mode, and/or the sampling rate may be decreased. Some embodiments may use identification information of a cell or cells of the communication network to determine whether the device is ‘static’ or moving. If it is determined that the device is static, for example in a static place, the physical sensor data and/or the virtual sensor data other than the identification information may not be requested from the sensor, or sensor data may be requested from one or from a limited set of sensors at longer intervals than in motion state. The term ‘static’ need not mean that the device is not moving at all but the device may move within an area, for example in an office, in a room, in a building, etc., and still it may be determined to be static. If it is determined that the device is not static the device may be ‘in motion’ or in another state, the device may start to receive physical sensor data and/or virtual sensor data from the sensors. When the device is determined to be ‘in motion’, the device may be moving from away one location so that the device is not determined to be ‘static’.

Examples of sensor data include audio data, represented e.g. as audio samples or using some encoding such as Adaptive Multi-Rate Wideband or MPEG-1 Audio Layer 3, image data (e.g. represented in Joint Photographic Experts Group JPEG format), accelerometer data (e.g. as values into three orthogonal directions x, y, z), location (e.g. as tuple comprising latitude and longitude), ambient light sensor readings, gyroscope readings, proximity sensor readings, Bluetooth® device identifiers, Wireless Local Area Network base station identifiers and signal strengths, cellular communication (such as 2G, 3G, 4G, Long Term Evolution) cellular tower identifiers and their signal strengths, and so on. Bluetooth® device identifiers, Wireless Local Area Network base station identifiers, cellular communication cellular tower (or cell) identifiers etc. are also called as cell identifiers (cell-ids) in this application and they can be regarded as representing one form of the virtual sensor data.

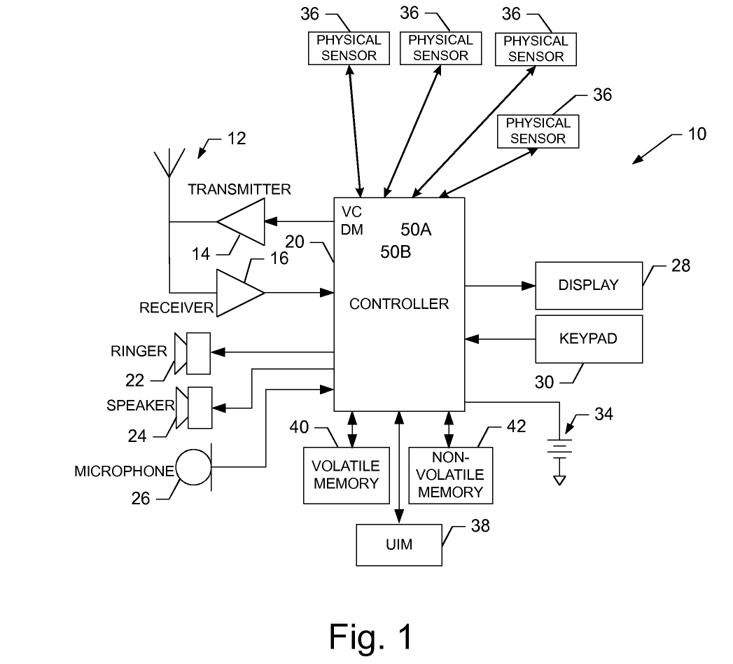

FIG. 1, one example embodiment, illustrates a block diagram of a mobile terminal 10 that would benefit from various embodiments. It should be understood, however, that the mobile terminal 10 as illustrated and hereinafter described is merely illustrative of one type of device that may benefit from various embodiments and, therefore, should not be taken to limit the scope of embodiments. As such, numerous types of mobile terminals, such as portable digital assistants (PDAs), mobile telephones, pagers, mobile televisions, gaming devices, laptop computers, cameras, video recorders, audio/video players, radios, positioning devices (for example, global positioning system (GPS) devices), or any combination of the aforementioned, and other types of voice and text communications systems, may readily employ various embodiments.

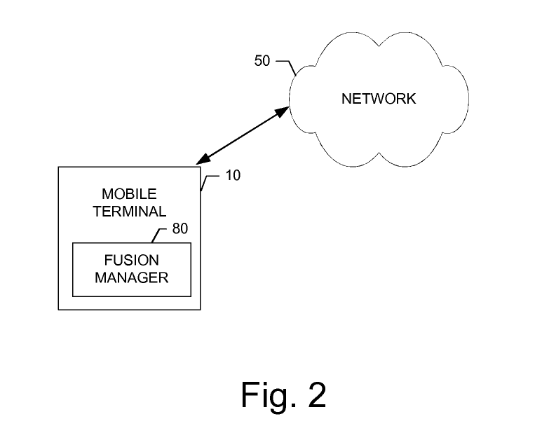

The mobile terminal 10 may include an antenna 12 (or multiple antennas) in operable communication with a transmitter 14 and a receiver 16. The mobile terminal 10 may further include an apparatus, such as a controller 20 or other processing device, which provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN, with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

In some embodiments, the controller 20 may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and/or soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface.

The mobile terminal 10 further includes a battery 34, such as a vibrating battery pack, for powering various circuits that are required to operate the mobile terminal 10, as well as optionally providing mechanical vibration as a detectable output.

In addition, the mobile terminal 10 may include one or more physical sensors 36. The physical sensors 36 may be devices capable of sensing or determining specific physical parameters descriptive of the current context of the mobile terminal 10. For example, in some cases, the physical sensors 36 may include respective different sending devices for determining mobile terminal environmental-related parameters such as speed, acceleration, heading, orientation, inertial position relative to a starting point, proximity to other devices or objects, lighting conditions and/or the like.

The mobile terminal 10 may further include a user identity module (UIM) 38. The UIM 38 may be a memory device having a processor built in. The UIM 38 may include, for example, a subscriber identity module (SIM), a universal integrated circuit card (UICC), a universal subscriber identity module (USIM), a removable user identity module (R-UIM), and/or the like. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10. For example, the memories may include an identifier, such as an international mobile equipment identification (IMEI) code, capable of uniquely identifying the mobile terminal 10.

FIG. 2 is a schematic block diagram of a wireless communications system according to an example embodiment. Referring now to FIG. 2, an illustration of one type of system that would benefit from various embodiments is provided. As shown in FIG. 2, a system in accordance with an example embodiment includes a communication device (for example, mobile terminal 10) and in some cases also additional communication devices that may be capable of communication with a network 50. The communications devices of the system may be able to communicate with network devices or with other communications devices via the network 50.

In an example embodiment, the network 50 includes a collection of various different nodes, devices or functions that are capable of communication with other communications devices via corresponding wired and/or wireless interfaces. As such, the illustration of FIG. 2 should be understood to be an example of a broad view of certain elements of the system and not an all inclusive or detailed view of the system or the network 50. Although not necessary, in some embodiments, the network 50 may be capable of supporting communication in accordance with any one or more of a number of first generation (1G), second generation (2G), 2.5G, third generation (3G), 3.5G, 3.9G, fourth generation (4G) mobile communication protocols, Long Term Evolution (LTE), and/or the like.

One or more communication terminals such as the mobile terminal 10 and the other communication devices may be capable of communication with other communications devices via the network 50 and may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (for example, personal computers, server computers or the like) may be coupled to the mobile terminal 10 via the network 50. By directly or indirectly connecting the mobile terminal 10 and other devices to the network 50, the mobile terminal 10 and the other devices may be enabled to communicate with other communications devices and/or the network, for example, according to numerous communication protocols including Hypertext Transfer Protocol (HTTP) and/or the like, to thereby carry out various communication or other functions of the mobile terminal 10 and the other communication devices, respectively.

Furthermore, although not shown in FIG. 2, the mobile terminal 10 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 may be enabled to communicate with the network 50 and other communication devices by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

Some of the above mentioned communication techniques may be called as short range communication in which the distance between communicating devices may be from a few centimeters to few hundred meters, and some of them can be called as long range communication techniques in which the distance between communicating devices may be from few hundred meters to tens of kilometers or even greater. For example, Bluetooth, WiFi, WLAN and Infrared are utilizing short-range communication techniques and cellular and other mobile communication networks may utilize long-term communication techniques.

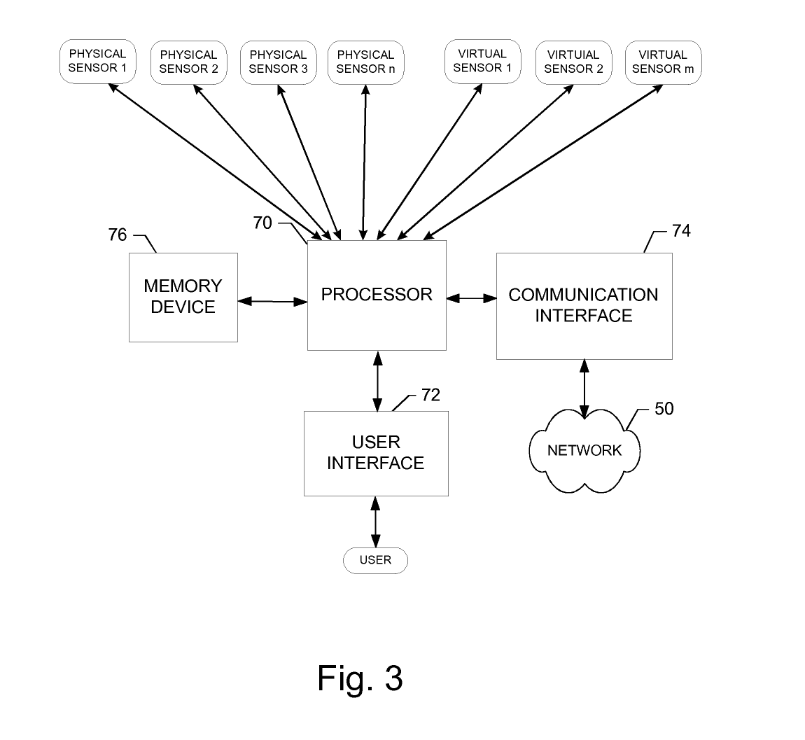

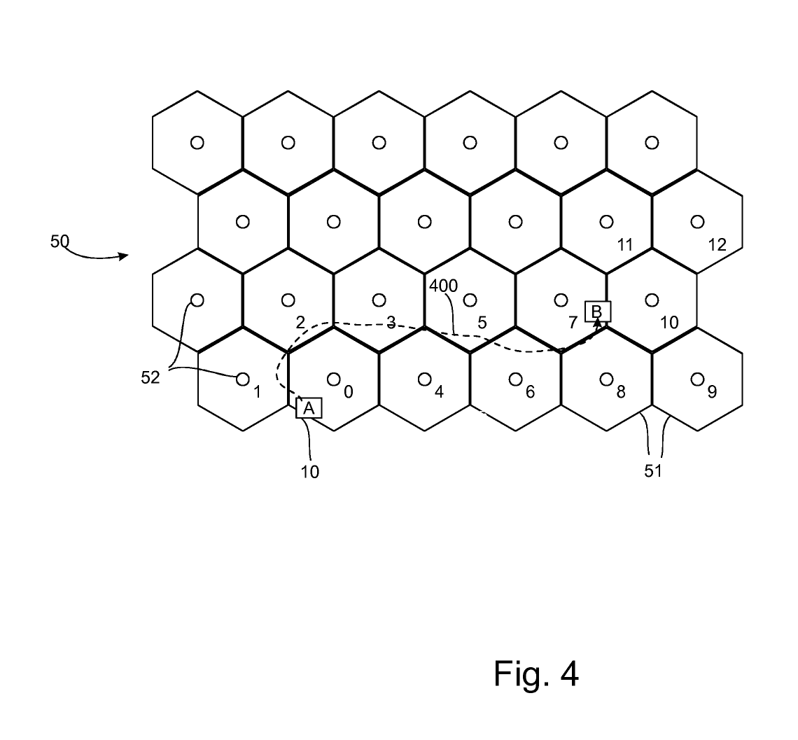

FIG. 3 illustrates a block diagram of an apparatus that may be employed at the mobile terminal 10 to host or otherwise facilitate the operation of an example embodiment. An example embodiment will now be described with reference to FIG. 3, in which certain elements of an apparatus for providing context determination (sensing), is displayed, and FIG. 4, in which an example of a part of cells of a communication network is illustrated. The apparatus of FIG. 3 may be employed, for example, on the mobile terminal 10. However, the apparatus may alternatively be embodied at a variety of other devices, both mobile and fixed (such as, for example, any of the devices listed above). Furthermore, it should be noted that the devices or elements described below may not be mandatory and thus some may be omitted in certain embodiments.

Referring now to FIG. 3, an apparatus for providing context sensing is provided. The apparatus may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (for example, a computer readable storage medium) comprising gates configured to store data (for example, bits) that may be retrievable by a machine (for example, a computing device). The memory device 76 may be configured to store information, data, applications, instructions or the like for enabling the apparatus to carry out various functions in accordance with example embodiments. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a microprocessor, a controller, a digital signal processor (DSP), a processing device with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (for example, the mobile terminal or other communication device) adapted for employing various embodiments by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an example embodiment in which the apparatus is embodied as a server or some other network devices, the user interface 72 may be limited, or eliminated. However, in an embodiment in which the apparatus is embodied as a communication device (for example, the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (for example, memory device 76, and/or the like).

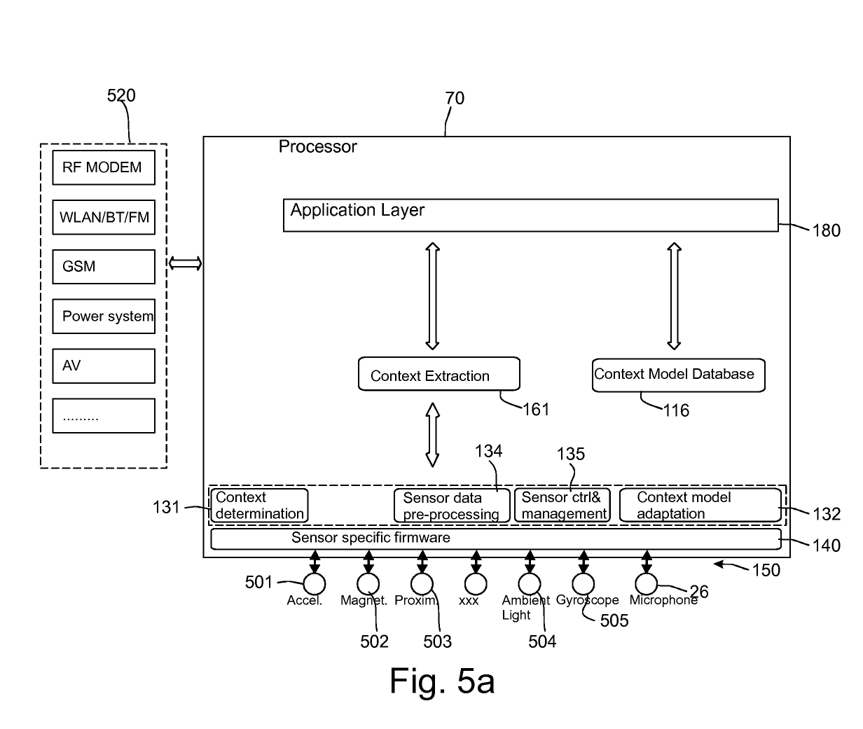

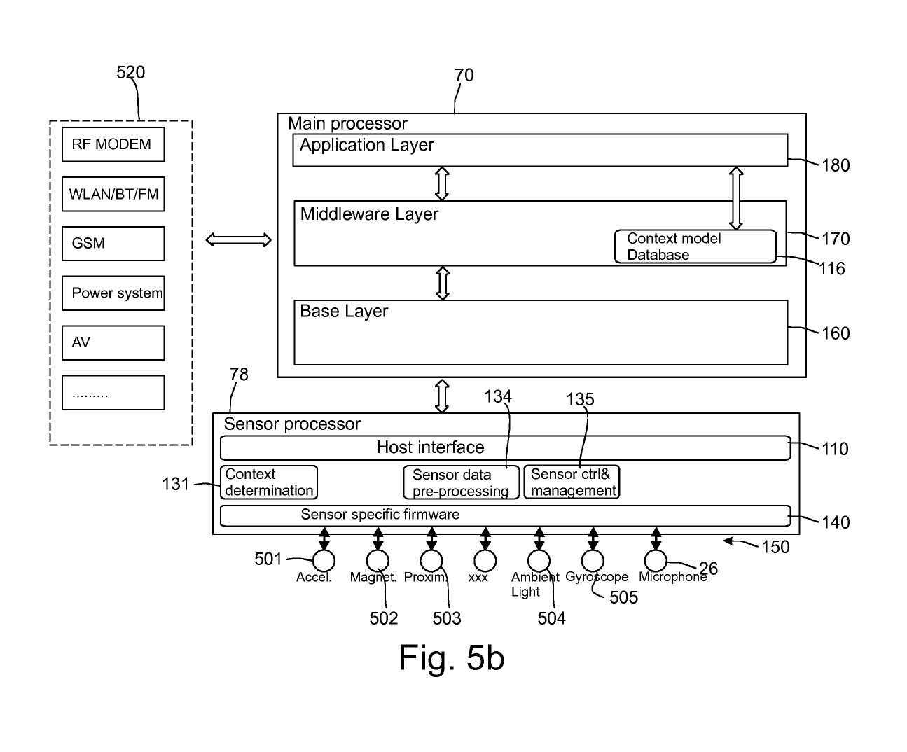

In the example embodiment of FIG. 3 the processor 70 is configured to interface with one or more physical sensors (for example, physical sensor 1, physical sensor 2, physical sensor 3, . . . , physical sensor n, where n is an integer equal to the number of physical sensors) such as, for example, an accelerometer 501 (FIG. 5a), a magnetometer 502, a proximity sensor 503, an ambient light sensor 504, a gyroscope 505, a microphone 26 and/or any of a number of other possible sensors. Accordingly, for example, the processor 70 may be configured to interface with the physical sensors via sensor specific firmware 140 that is configured to enable the processor 70 to communicate with the physical sensors. In some embodiments, the processor 70 may be configured to extract information from the physical sensors (perhaps storing such information in a buffer in some cases), perform sensor control and management functions 135 for the physical sensors and perform sensor data pre-processing 134. In an example embodiment, the processor 70 may also be configured to perform context determination 131 with respect to the physical sensor data extracted.

In some other example embodiments, the apparatus may further include a sensor processor 78 (FIG. 5b). The sensor processor 78 may have similar structure (albeit perhaps with semantic and scale differences) to that of the processor 70 and may have similar capabilities thereto.

In an example embodiment, the processor 70 is configured to interface with one or more virtual sensors 520 (for example, virtual sensor 1, virtual sensor 2, . . . , virtual sensor m, where m is an integer equal to the number of virtual sensors) in order to fuse virtual sensor data with physical sensor data. Virtual sensors may include sensors that do not measure physical parameters. Thus, for example, virtual sensors may monitor such virtual parameters as RF activity i.e. the activity of the transmitter 14 or the receiver 16 of the device 10, time, calendar events, device state information, active profiles, alarms, battery state, application data, data from web services, certain location information that is measured based on timing (for example, GPS position) or other non-physical parameters (for example, cell-id), and/or the like. The virtual sensors may be embodied as hardware or as combinations of hardware and software configured to determine the corresponding non-physical parametric data associated with the respective virtual sensor.

As the processor 70 itself is a processor running an operating system, the virtual context fusion processes running in the processor 70 may have access to the context and physical sensor data. The processor 70 may also have access to other subsystems with physical data sources and virtual sensors.

In an example embodiment the processor 70 may be provided with a number of different operational layers such as a base layer 160, a middleware layer 170 and an application layer 180 as illustrated in FIG. 5b. Hence, the operations of the processor may be implemented in the same or in different layers. For example, the context model database 116 may be located at one of the layers. Also the context determination 131 may be implemented in different layers in different embodiments.

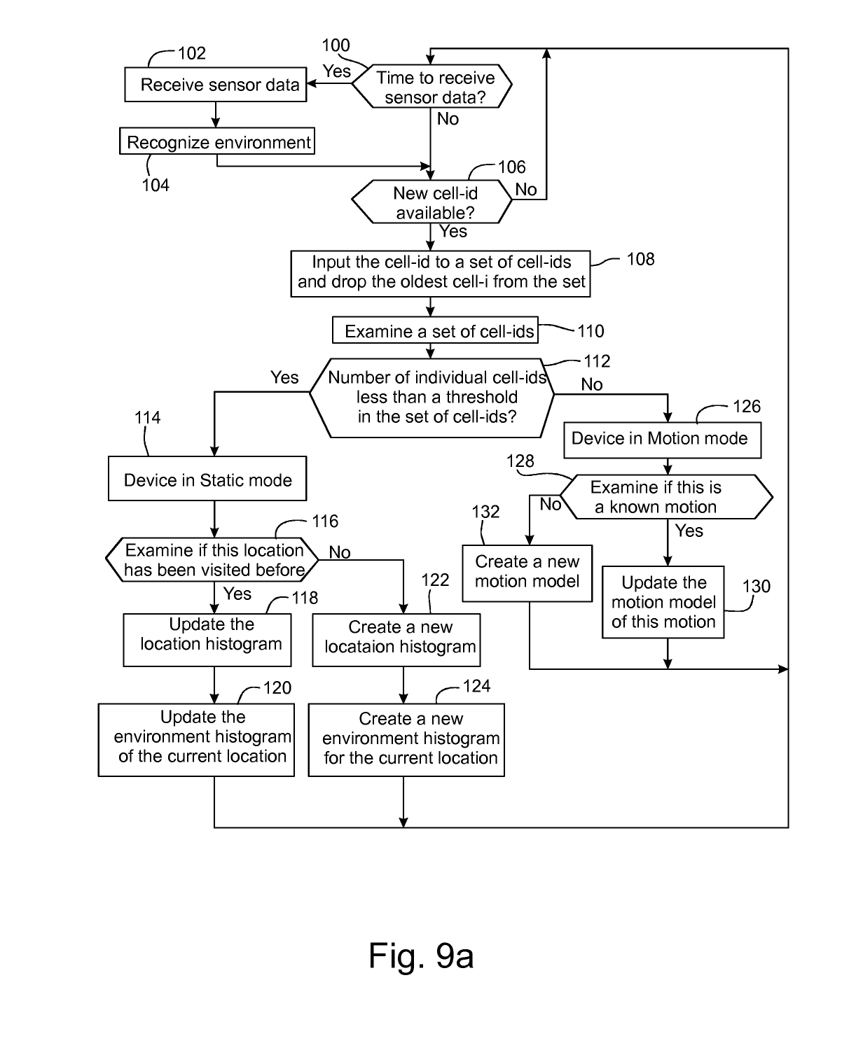

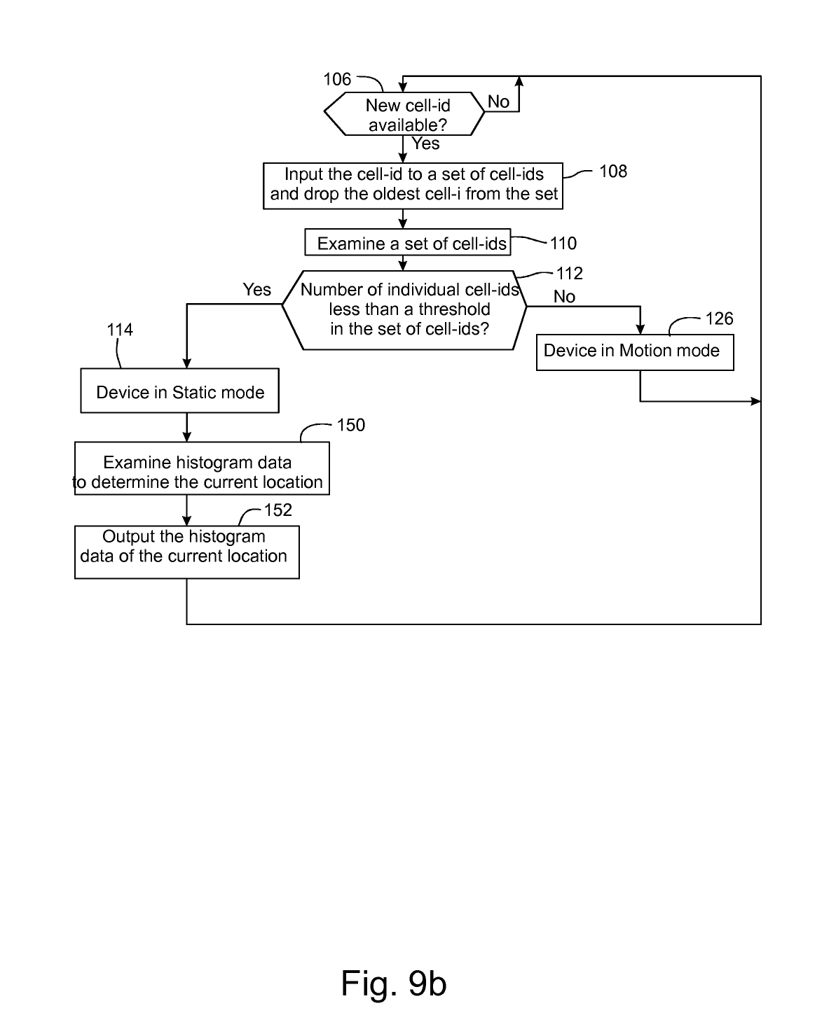

FIG. 9a illustrates a conceptual flow diagram of the context sensing process provided by an example embodiment. As shown in FIG. 9a, the identifier based data (e.g. cell-ids) from the communication network the user visits can be used to determine whether the user is static (such as at the office, at home, at the grocery store). This may be done e.g. by recording the user's current cell-id at regular intervals, once every minute for example. Ideally, when the user and the phone are not moving, the device would be connected to a single cell-id. In practice, the phone may switch between a few values even when not moving. To detect a static state, a method can be used which inspects the cell-ids inside a moving analysis window.

The operation of an example embodiment of the present invention will now be disclosed in more detail with the example situation presented in FIG. 4 and the flow diagram of FIG. 9a. In FIG. 4 the hexagons illustrate cells 51 i.e. serving areas of access points 52 such as base stations of the communication network 50. The circles within the hexagons illustrate access points 52 of the communication network 50. The dotted arrow 400 illustrates an example of a travelling route of the user. It should be noted here that although the cells are depicted as identical hexagons, in practice the form of the cells are not identical and not hexagons but the landscape, weather conditions etc. may affect to the form and size of the cells. Furthermore, especially when the device 10 is located farther from an access point 52 the device 10 may be able to communicate with other access point(s) than the access point nearest to the device 10. Also, as was already mentioned above, the serving access point may vary from time to time although the device 10 were not moving or moves quite slowly.

In the illustrative example of FIG. 4 the user is first located in Location A and the device 10 is not moving. Although there may be no calls or other communication activities going on, the device 10 may communicate with the communication network at intervals and receive location information (e.g. cell-ids) from the communication network 50 (blocks 106 and 108 in FIG. 9a). The device 10 may be in such a location that the location information is not static but the communication network may change the access point 52 (and hence the location information) due to e.g. changes in signal strengths the device 10 receives from the access point and/or the access point receives from the device 10. The cell-ids may be collected in windows of N samples for analysis. If there are less than a predefined number of unique cell-ids in the window, the window may be considered static. This is illustrated with blocks 110, 112 and 114 in FIG. 9a. If there are more than the predefined number of unique cell-ids in the window, the window may be considered a motion window. This is illustrated with blocks 110, 112 and 126 in FIG. 9a. If there are enough static windows between motion windows (for example, 20 minutes worth of static windows), the cell-ids recorded during those windows may be considered to be from one single static location.

The term window or moving analysis window is used here to simplify the description of the operation. In this context it means a set of consecutive samples of cell-ids or other identifiers which may have been stored into a buffer in a memory and the controller 50 keeps track on the location of the window in the buffer. The controller 50 may then use those sample values of the buffer which reside in the window to determine the context of the device 10. When the window is forwarded to the next position, the controller advances the window in the buffer so that the beginning of the window is moved to the next memory location and the length of the window is kept constant. The buffer may be a so called circular buffer wherein at the end of the buffer the window is split to two parts so that the first part includes some values from the end of the buffer and the second part includes some values from the beginning of the buffer so that the total length of the first and the second part equals the length of the window.

Another example to implement the window is a structure known as a shift register. The shift register has storage places for at least so many cell-ids as is the length of the window. When a new cell-id is entered, the values in the shift register is shifted once and the oldest value in the shift register can be dropped.

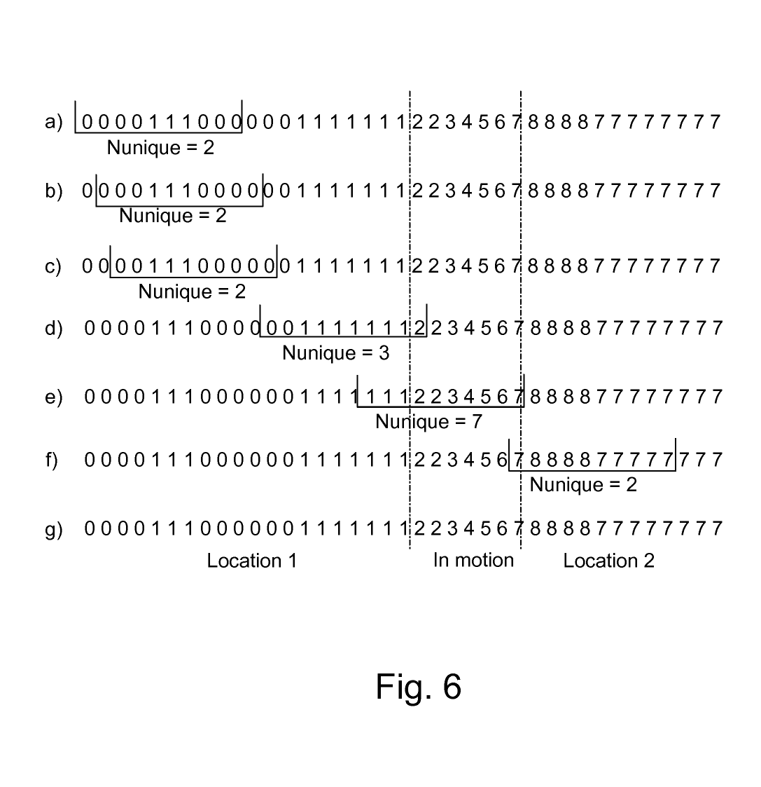

An example of a sequence of cell-ids is depicted in FIGS. 6a-6g. The numbers represent cell-ids recorded at regular intervals (for example once every minute). The bracket represents a moving analysis window on the cell-id data. As an example, it is assumed that the device 10 uses a moving analysis window of 10 cell-ids (i.e. N=10) to determine whether the device 10 is static or in motion. In FIG. 6a the device 10 (e.g. the processor 70 of the device) is examining the first 10 cell-ids and the corresponding sequence is ‘0000111000’. Hence, there are only two cell-ids present in this sequence. A variable Nunique can then be set to the value 2. The device 10 may compare the value of Nunique with one or more thresholds to determine whether the device is static or in motion, or perhaps starting to move, or coming into a steady state. In the example of FIG. 6a the value of Nunique is 2 and the threshold have been set to 3. Hence, the value of Nunique is less than the threshold. Therefore, the device 10 determines that the device 10 is static. The device continues to receive cell-ids and, according to the example of FIG. 6b, at a following examination phase a new cell-id (0) has been received. The moving analysis window is also advanced forwards so that the first value in the moving analysis window is dropped and the new cell-id is set to the last ID-value in the moving analysis window. Then, the moving analysis window includes the following sequence of cell-ids: ‘0001110000’. The variable Nunique still has the value 2 and it is determined that the device is still static.

The process may continue as described above and the sequence of cell-ids and the moving analysis window may advance as illustrated in FIGS. 6c-6g. At the moment illustrated by FIG. 6c the sequence of cell-ids in the moving analysis window is ‘0011100000’ and the value of the variable Nunique is 2. Hence, it can be deduced that the device 10 is static. At the moment illustrated by FIG. 6d the sequence of cell-ids in the moving analysis window is ‘0011111112’ and the value of the variable Nunique is 3. Hence, the value of Nunique is not less than the threshold which may be interpreted so that the device 10 is in motion. At the moment illustrated by FIG. 6e the sequence of cell-ids in the moving analysis window is ‘1112234567’ and the value of the variable Nunique is 7. Hence, the value of Nunique is not less than the threshold which may be interpreted so that the device 10 is in motion. At the moment illustrated by FIG. 6f the sequence of cell-ids in the moving analysis window is ‘7888877777’ and the value of the variable Nunique is 2. Hence, the value of Nunique is less than the threshold which may be interpreted so that the device 10 is static. Due to the difference in cell-ids in the moving analysis window of FIGS. 6a and 6f it can be deduced that the device 10 has arrived to a different location than the location from which it started to move. This will be explained in more detail below.

According to an example embodiment, location histograms may be used to evaluate 116 whether the location the device 10 is located has already been visited before or not: The device 10 may calculate histograms of locations (location histograms) where the device has been determined to be static; the location histograms may be stored to the memory; and a new location histogram may be compared to the stored location histograms to evaluate whether the current location has previously been visited or not. This may be performed as follows. Once a static state has been detected, a histogram of the cell-ids is determined from the cell-ids seen during the static windows. The histogram may be then normalized such that the values of the histogram sum up to one. This normalized histogram can be compared to already existing (if any) location histograms. If a matching location histogram is found from the stored location histograms, the counts of the new histogram are added 118 to the matching histogram. If no matching histogram is found the new histogram is stored 122 as a new location in the memory.

The similarity of two histograms Hⁱ and H^{j} can be calculated using the following formula:

$${S}_{i , j} = {\sum }_{k = 1}^{M} min ( {H}_{k}^{i} , {H}_{k}^{j} ) \qquad ( 1 )$$

where M is the number of distinct cell-ids seen by the system and Hₖⁱ is the (normalized) count of cell-id k in the histogram i.

In addition to the ‘static’ locations explained in above, ‘in motion’ may also be used for low-power sensing. In this context ‘in motion’ is defined as something that happens between two ‘static’ locations. For example, the user travels from one location to another location and during the travelling the device 10 receives cell-ids of access points which the device have communicated with during the travelling. Once two consecutive ‘static’ locations have been found, the list of cell-ids between these places may be used to define ‘in motion’.

Once ‘in motion’ has been found it can be checked 128 whether it is a new motion or one that have occurred before. When dealing with the static locations the histogram approach was used for this. However, for the motion case, the ordering of the cell-ids is meaningful, thus the histogram approach may not be the optimal method. Instead some other models such as a Markov model or an edit distance based approach can be used for defining different motions.

For the Markov chain case, a Markov model for known motions is held in the memory. The model consists of states that correspond to cell-ids and transitions (with probabilities) between the states. Once a string of cell-ids for a motion is obtained, it can be checked if the string fits any of the stored models 130 (i.e. it is possible to traverse through the model using the string of cell-ids). If no matching model is found, a new model is created 132 that matches the cell-id string.

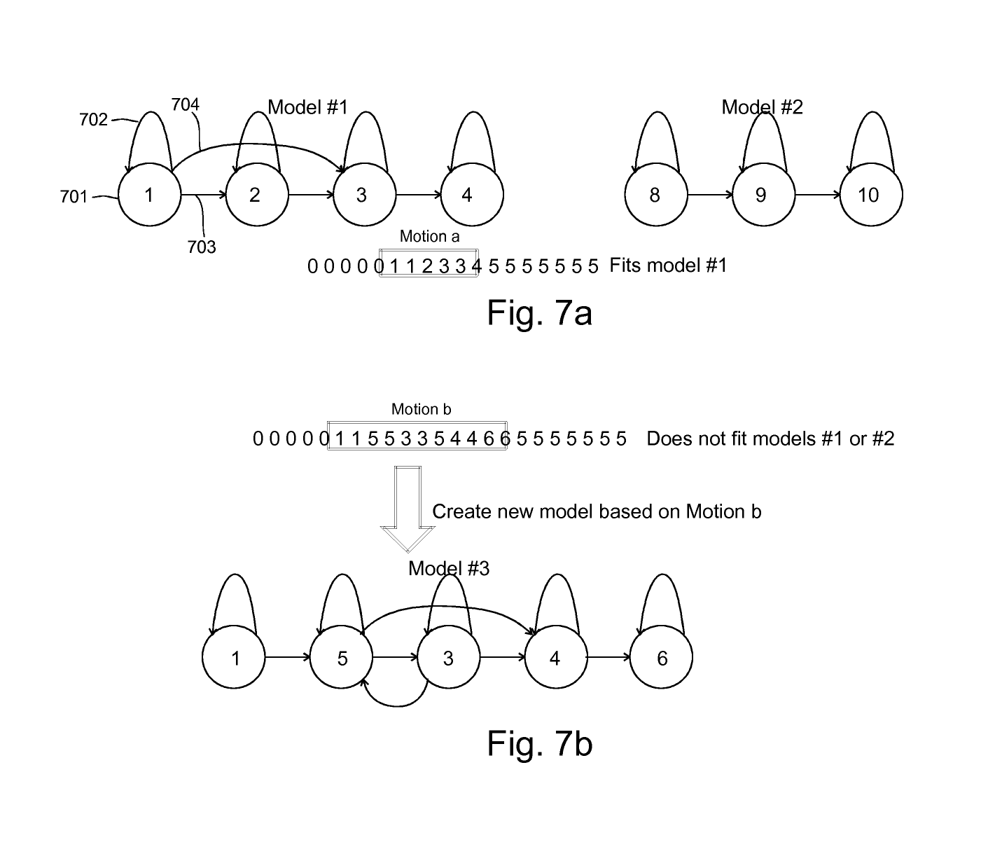

It is possible for two or more models to fit a string of cell-ids. In this case the model that most likely produced (based on the transition probabilities) the string is chosen. If a match is found the transition probabilities of the matching model are updated based on the list of cell-ids. Examples can be found in FIGS. 7a and 7b.

Instead of the likelihoods obtained in the above approach, an edit distance can also be used for determining the distance between two motions. The Levenshtein distance, for example, can be used to determine the distance between two strings of cell-ids.

FIGS. 7a and 7b depict two examples of determining whether ‘in motion’ is a known motion or an unknown one. In FIGS. 7a and 7b the circles represent states (cell-ids) and the arrows represent probabilities for different transitions. For example, for the first state 701 (cell_ID=1) in FIG. 7a there may be a first probability 702 to remain in the same state (in the same cell), a second probability 703 to change the state to the second state (i.e. to the cell-id 2), and a third probability 704 to change the state to the third state (i.e. to the cell-id 3).

First a motion may be obtained e.g. by using the list of cell-ids detected during the motion. In this example the list of cell-ids is 1, 1, 2, 3, 3, 4. This is depicted as Motion a in FIG. 7a. Then, the detected list of cell-ids is checked against the existing motion models. In the example of FIG. 7a there are two motion models, namely Model #1 and Model #2. In this example the detected list of cell-ids fits model #1 and it can be concluded that the motion is indeed a known motion. Hence, the parameters (transition probabilities) of the matching model can be updated. In the second example depicted in FIG. 7b the list of cell-ids 1,1,5,5,3,3,5,4,4,6,6 (depicted as Motion b in FIG. 7b) does not match any of the existing models. Thus, it can be determined that the motion is a new motion and a new model (Model #3) matching the string may be created.

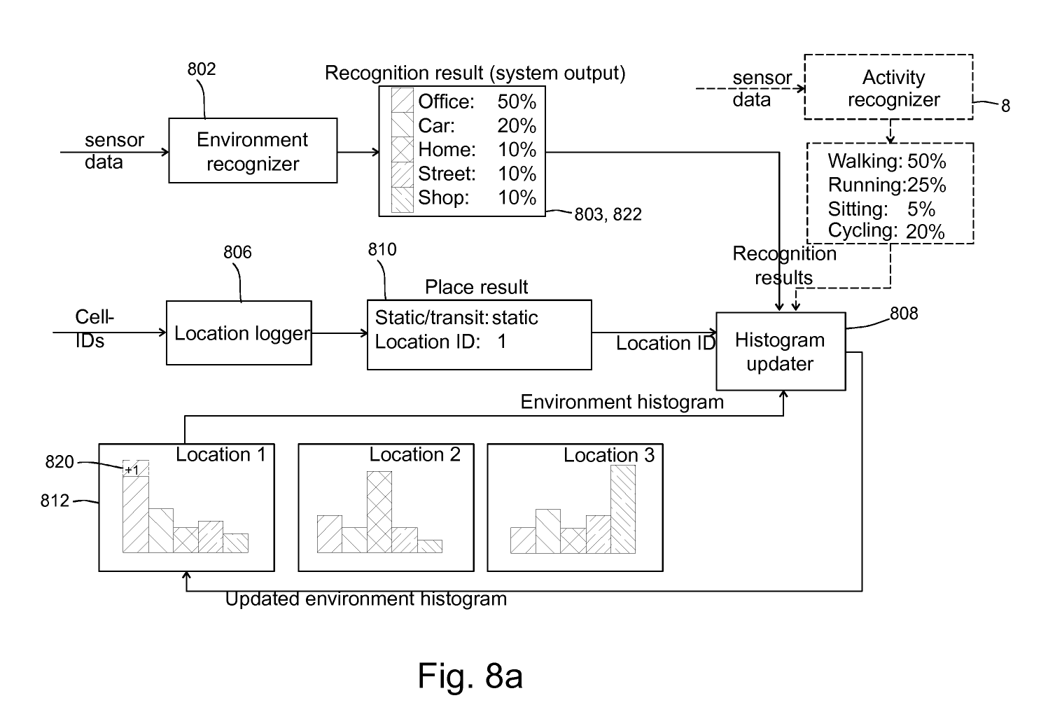

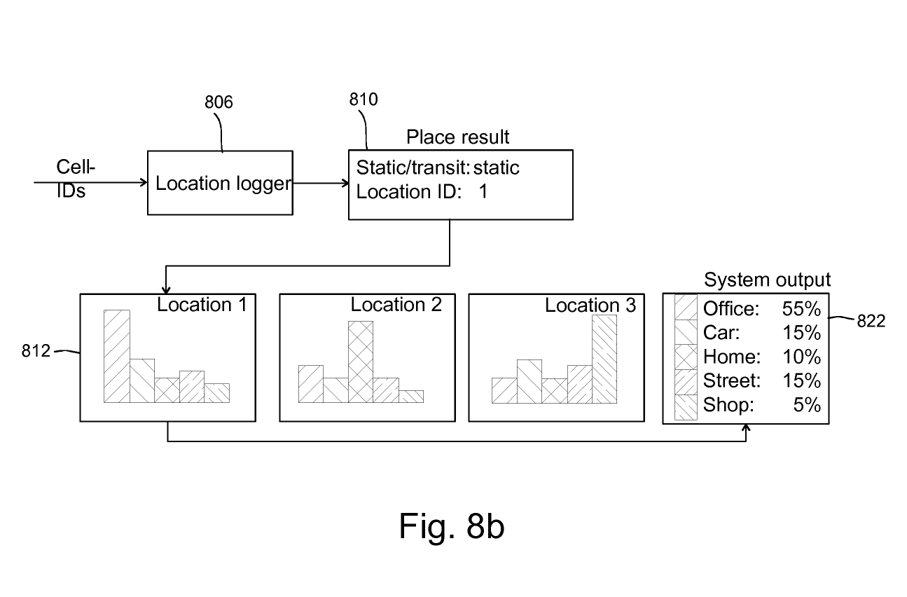

Once it has been determined that the user is in a specific ‘static’ location or ‘in motion’, an environment recognizer 802 and an activity recognizer 804 can be run periodically. The number of times an environment and activity is recognized 104 is stored in environment histogram and activity histogram for the current location. Thus, for locations the user visits, two histograms describing the occurrence counts of environments and activities may be stored. FIG. 8a depicts an example of how this works. The location detector 806 may determine that the device is in location ‘1’. When the environment recognizer 802 is run, the following formula may be used e.g. by the histogram updater 808 to update the environment histograms:

Cᵢ^{a}=Cᵢ^{a}+1 (2)

where Cᵢ^{a} is the number of times environment i has appeared in location a. For example, if the environment recognizer 802 indicates that the greatest probability of the current location a is office, the value of C_{office}^{a} is increased by one. Similarly, the activity histogram of the detected activity in the environment i may be updated by adding the value 1 to the activity Rᵢ^{a}.

In the example of FIG. 8a the location detector 806 provides an indication 810 of the status of the device 10 and if it has determined that the device 10 is static, the location detector 806 may also provide an indication of the current location of the device 10 (location ID). The histogram updater 808 may use this data to update 120 the environment histograms for the detected location. The histogram updater 808 may use the output 803 of the environment recognizer 802 when updating the histograms. In the example of FIG. 8a the environment recognizer 802 outputs probabilities for recognizable environments. In this example the probabilities are: Office 50%, Car 20%, Home 10%, Street 10%, and Shop 10%. Hence, the histogram updater 808 increases the value of ‘office’ in the histogram 812 of Location 1 (depicted with 820 in FIG. 8a) by one. In normal operation the probabilities may be the output 822 from the system. In the background the location detection may be run simultaneously.

If it has been determined that the device 10 is static, but the current location has not been visited before, the device 10 may create 124 a new environment histogram for the current location.

In addition to providing the most likely environment or activity, the environment recognizer 802 and the activity recognizer 804 are usually able to provide likelihoods for all recognizable environments and activities. These likelihoods can also be used to update the histograms instead of counting the recognizer results. In this case, the update formula can be expressed as:

Cᵢ^{a}=Cᵢ^{a}+Pᵢ, i=1 . . . V (3)

where Pᵢ is the likelihood (or probability) of environment i and V is the total number of environments.

FIG. 8b illustrates how the system may operate according to an example embodiment in a low-power mode when the environment recognizer 802 is turned off. The operations depicted with blocks 106, 108, 110, 112, 114 and 126 may contain similar operations than the blocks 106, 108, 110, 112, 114 and 126 of the embodiment depicted in FIG. 9a. In the embodiment of FIG. 9b, if it has been determined that the device is in static mode and the location detector 806 may use histogram data and determine 150 that the device is in location ‘1’. The recognition output 152 is now obtained from the environment histogram for this location, instead of the audio-based environment classifier or other environment recognizer 802. The histogram for location ‘1’ may be normalized such that its values sum to unity and the normalized histogram values are given as the system output 822.

In some embodiments the context histogram values are not updated when the context prediction is done based on context histograms. This prevents the system from corrupting the histogram counts. Only sensor-based classifications may update the histogram counts.

The power savings may occur in this case because obtaining the cell-id bears negligible additional power consumption compared to running the device sensors, because the device is anyway connected to the communication network. In addition, the cell-id histogramming operations and histogram comparison operations may be significantly lighter than the calculations needed to obtain the environment based on audio data. For example, the data rate of audio, typically 8000 Hz-16000 Hz, may be significantly higher than the data rate of reading cell-ids e.g. once per second.

It should be noted that there are various possibilities to modify the invention. For example, in some embodiments there might be more states than “static” or “in motion”. For example, there might be an intermediate state which is something between ‘in motion’ or ‘static’, or an unknown state when the system cannot determine which of the other states to use. In some embodiments, some other context model than a histogram could be associated to the states. Examples include continuous probability densities such as a normal density or simply storing the most probable context value for this state.

There are several options to enable/disable the low-power context sensing mode. The power-saving mode may enable itself automatically when it detects that the user is in a location with a high enough number of context classifications made using device sensors. There may be a threshold, for example 10, of context classifications, that need to have been done in the location before the power saving mode is triggered. The number of context classifications in the location can be obtained by summing the unnormalized histogram counts Cᵢ^{a} for location a over contexts i. However, it is possible to make predictions even after just one context classification for the location, but the likelihood of producing a correct classification may increase after more actual classifications have been accumulated.

The power-saving mode may also enable itself periodically when a certain number of classifications have been obtained for a location. For example, after obtaining 10 context classifications for a location, the device may start to intermittently perform context classification using low-power mode. For example, after 10 context classifications the system may start to perform every fourth context classification in low-power mode (using histogram counts); after 20 context classifications, every third context classification may be obtained using the histogram counts; after 30 context classifications, every second context classification may be obtained using the histogram counts; and after 40 context classifications, there may be e.g. one sensor-based context classification per 10 histogram based low-power classifications.

The frequency of using the low-power mode may be determined based on analyzing the success of predictions made using the low power mode. For example, if the system receives input from the user that histogram-based classifications are correct, it may use the low-power histogram-based classifications more often. Correspondingly, if the system receives input that the low-power classifications are incorrect, it may resort more to sensor-based classifications.

In some embodiments it may also be possible to determine the frequency of using the low-power mode on the basis of the frequency of detected changes in cell-ids. For example, if the detected list of cell-ids is ‘0100101100101’, the device 10 could determine that the device is not static although there are only two different cell-ids in the list. On the other hand, if the list of cell-ids were like ‘0000111100000’, the device 10 could determine that the device is static because there are quite a long periods in which the cell-id does not change at all.

The low-power mode may be enabled automatically when the battery level goes below a predetermined threshold (e.g. 50% of the full capacity). The low-power mode may be disabled automatically when an energy level in a battery of the apparatus exceeds a predetermined threshold. Alternatively or in addition to, the frequency of operating in low-power mode may be adjusted based on the energy level in the battery of the apparatus. That is, the lower the energy level in the battery, the more often the system may obtain the recognition based on the histograms instead of running device sensors.

As a particular example, the system may disable the low-power mode entirely when the device is being charged. This may be particularly advantageous if there are not many sensor-based context classifications for the location where the device is being charged. Running the sensor-based classifications when the device is being charged allows the device to obtain good histogram of context classifications for this location, such that next time the classifications can be made based on the histograms.

The user may enable/disable the low-power mode manually. The low-power context sensing mode may also be linked to the device power saving options, such that when the power saving mode is on, the context sensing also goes to the low-power mode.

FIG. 5a shows one embodiment of the system implementation architecture. All of the sensors including a microphone 26 are interfaced to the processor 70.

When the device 10 is operating, sensors may provide sensor data through the hardware interface 150 to sensor specific firmware modules 140 in which the sensor data may be converted to a form appropriate for the processor 70. In some embodiments the data conversion may include analog to digital conversion to form a digital representation of the analog sensor data and sampling the digital representation to form sensor data samples. Sensor data samples may be stored into a memory or they may be provided directly to the management module 120. The processor 70 thus collects sensor data from the sensors and the sensor data pre-processing module 134 may pre-process the sensor data, when necessary.

When the context sensing module 131 performs the environment and activity classification it may use sensor data from one or more sensors and corresponding context models. For example, the context sensing module 131 may use audio data captured by the microphone to determine in which kind of environment the device 10 is located. The context sensing module 131 may use another sensor data to determine the current activity of the user of the device 10. For example, the context sensing module 131 may use the accelerometer data to determine whether the user is moving, e.g. running, cycling or sitting. It is also possible that two or more different kinds of sensor data is used to evaluate similar context types, e.g. whether the user is indoors or outdoors, sitting in a bus or train etc.

The context sensing module 131 performs feature extraction on the basis of sensor data. Details of the feature extraction depend inter alia on the type of sensor data. As an example, if the sensor data is accelerometer data the extracted features may include acceleration value or a change in the acceleration value. In case of proximity data the extracted feature data may include distance values or a difference between distance values of a previous distance and the current distance. In case of audio data the extracted features may be provided in the form of a sequence of Mel-frequency cepstral coefficient (MFCC) feature vectors, for example. It should be noted, however, that the above mentioned features are only non-limiting examples of results the feature extraction may produce but also other kind of features may be produced as well.

When the features have been extracted the context sensing module 131 may use context models stored. e.g. in a context model database 116 (FIG. 5a) to evaluate, for example, a list of probabilities for different environment and/or activity alternatives. In some embodiments the same sensor data may be used with different context models so that probabilities for different environments/activities can be obtained. The context sensing module 131 may examine the list of probabilities to determine whether it is possible to conclude the environment and/or the activity with high enough confidence or not. In one embodiment the probabilities (confidence values) of two most probable contexts in the list are compared with each other and if the difference between these two values is high enough i.e. greater than a first threshold, the context sensing module 131 may determine that the context has been determined with high enough confidence. In another embodiment the context sensing module 131 evaluates the value of the highest probability in the list of probabilities to determine whether the probability is high enough or not. Therefore, the value of the most probable context may be compared with a second threshold to determine how confident the most probable context is. In a still further embodiment both of the above mentioned criteria may be used i.e. is the highest probability high enough and is the difference large enough.

In yet another example embodiment the identifier based data from one or more devices near the user's device implementing the present invention may be used to determine the current context of the user's device. For example, there may be several Bluetooth® devices having a unique identifier nearby. When the user's device receives device identifiers from such devices and forms the set of identifier data, the user's device may determine whether the user is in a certain environment such as at the office or another location where the similar set of identifier data can be detected. As a further example, the user may have certain devices along, such as mobile phone and a laptop computer, when he intends to do some office work at home or at other location outside the office, wherein the user's device which performs the context sensing may determine that the user is in an office environment.

It should be noted that there may be a plurality of different contexts for the same status of the device. For example, a plurality of contexts may be determined for the ‘static’ state (e.g. for different kinds of office environments, grocery stores, homes, etc.) and for the ‘in motion’ state.

FIG. 9a is a flowchart of a method and program product in a first mode of operation according to example embodiments. The first mode of operation may be a normal operation mode in which both the environment determination and histogram adaptation is operating. FIG. 9b is a flowchart of a method and program product in a second mode of operation according to example embodiments. The second mode of operation may be a low-power operation mode in which the histogram adaptation is not operating and the environment determination is not using physical sensor data. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In an example embodiment, an apparatus for performing the method of FIGS. 9a and 9b above may comprise a processor (e.g., the processor 70) configured to perform some or each of the operations (100-152) described above. The processor may, for example, be configured to perform the operations (100-152) by performing hardware implemented logical functions, executing stored instructions, or executing algorithms for performing each of the operations. Alternatively, the apparatus may comprise means for performing some or each of the operations described above. In this regard, according to an example embodiment, examples of means for performing operations 100-152 may comprise, for example, the processor 70 and/or a device or circuit for executing instructions or executing an algorithm for processing information as described above. Many modifications and other embodiments set forth herein will come to mind to one skilled in the art to which these inventions pertain having the benefit of the teachings presented in the foregoing descriptions and the associated drawings.

Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

In the following some examples will be provided.

1. A method comprising:
receiving at least one identifier data relating to a communication network;
examining a set of identifier data to identify number of different identifier data in the set of identifier data;
on the basis of the examining determining a status of an apparatus; and
if the examining indicates that the status of the apparatus is a first state, examining context data relating to the first state to determine a current context of the apparatus.

2. The method according to the example 1, comprising using the context data to replace context data obtained by analyzing sensor data or using the context data in addition to context data obtained by analyzing sensor data.

3. The method according to the example 1 or 2, wherein the context data relating to the first state relates to past contexts.

4. The method according to the example 1, 2 or 3, comprising using the set of identifier data to determine a location.

5. The method according to the example 4, comprising using a context data relating to the location to determine the current context of the apparatus.

6. The method according to any of the examples 1 to 5, wherein the context data comprises at least one of:
a histogram of past contexts;
activity data; and
environment data.

7. The method according to any of the examples 1 to 6, comprising collecting histogram of environments or activities or both.

8. The method according to any of the examples 1 to 7, wherein in the first state the apparatus is determined to be static.

9. The method according to any of the examples 1 to 8, wherein if the examining indicates that the status of the apparatus is a second state, the apparatus is determined to be in motion.

10. The method according to the example 9, wherein if the examining indicates that the status of the apparatus is in motion, examining the set of identifier data to determine a motion path of the apparatus.

11. The method according to any of the examples 1 to 10, further comprising comparing the number of different identifier data with a first threshold; and determining that the apparatus is in the first state if the number of different identifier data is less than the first threshold.

12. The method according to any of the examples 1 to 11, further comprising examining the number of detected changes in identifier data; and determining that the apparatus is in the first state if the number of detected changes in identifier data is less than a second threshold.

13. The method according to any of the examples 1 to 14, further comprising examining the identifier data periodically.

14. The method according to any of the examples 1 to 13, further comprising using a certain number of identifiers in the set of identifiers.

15. The method according to the example 14, further comprising inserting an identifier in the set of identifiers, and removing another identifier from the set of identifiers.

16. The method according to any of the examples 1 to 15, further comprising using an identifier of an access point of the communication network as the identifier data.

17. The method according to the example 16, wherein the identifier is a cell identifier.

18. The method according to the example 16 or 17, wherein the access point is at least one of the following:
an access point of a wireless local area network;
a base station of a cellular communications network;
a short-range communication device.

19. The method according to any of the examples 1 to 18, further comprising:
using the set of identifier data to determine a current location of the apparatus;
comparing the current location with a set of previous location information;
conditionally creating a new location information, if the comparison indicates that the current location is a new location.

20. The method according to any of the examples 1 to 19, comprising defining a low-power context sensing mode of the apparatus.

21. The method according to the example 20, further comprising determining how many times the context has been obtained by analyzing sensor data.

22. The method according to the example 21, further comprising using the number of times the context has been obtained to enable or disable the low-power context sensing mode.

23. The method according to the example 20, 21 or 22, further comprising gradually increasing a frequency of operating in the low-power context sensing mode.

24. The method according to any of the examples 20 to 23, further comprising obtaining indication of the correctness of the context data, and using the indication to control the frequency of operating in the low-power context sensing mode.

25. The method according to any of the examples 20 to 24, further comprising enabling the low-power context sensing mode when an energy level in a battery of the apparatus is below a predetermined value.

26. The method according to any of the examples 20 to 25, further comprising adjusting the frequency of operating in the low-power context sensing mode based on an energy level in a battery of the apparatus.

27. The method according to any of the examples 20 to 26, further comprising disabling the low-power context sensing mode when the apparatus is being charged.

28. The method according to any of the examples 20 to 27, further comprising manually enabling or disabling the low-power context sensing mode.

29. The method according to any of the examples 20 to 28, wherein the apparatus comprises a power saving mode, wherein the method comprises enabling the low-power context sensing mode when the power saving mode of the apparatus is on.

30. An apparatus comprising a processor and a memory including computer program code, the memory and the computer program code configured to, with the processor, cause the apparatus:
to receive at least one identifier data relating to a communication network;
to examine a set of identifier data to identify number of different identifier data in the set of identifier data;
on the basis of the examining to determine a status of the apparatus; and
if the examining indicates that the status of the apparatus is a first state, to examine context data relating to the first state to determine a current context of the apparatus.

31. The apparatus according to the example 30, the memory and the computer program code configured to, with the processor, cause the apparatus to use the context data to replace context data obtained by analyzing sensor data or using the context data in addition to context data obtained by analyzing sensor data.

32. The apparatus according to the example 30 or 31, wherein the context data relating to the first state relates to past contexts.

33. The apparatus according to the example 30, 31 or 32, the memory and the computer program code configured to, with the processor, cause the apparatus to use the set of identifier data to determine a location.

34. The apparatus according to the example 33, the memory and the computer program code configured to, with the processor, cause the apparatus to use a context data relating to the location to determine the current context of the apparatus.

35. The apparatus according to any of the examples 30 to 34, wherein the context data comprises at least one of the following:
a histogram of past contexts;
activity data;
environment data.

36. The apparatus according to any of the examples 30 to 35, the memory and the computer program code configured to, with the processor, cause the apparatus to collect histogram of environments or activities or both.

37. The apparatus according to any of the examples 30 to 36, wherein in the first state the apparatus is determined to be static.

38. The apparatus according to any of the examples 30 to 37, wherein if the examining indicates that the status of the apparatus is a second state, the apparatus is determined to be in motion.

39. The apparatus according to the example 38, wherein if the examining indicates that the status of the apparatus is in motion, the memory and the computer program code is further configured to, with the processor, cause the apparatus to examine the set of identifier data to determine a motion path of the apparatus.

40. The apparatus according to any of the examples 30 to 39, the memory and the computer program code further configured to, with the processor, cause the apparatus to compare the number of different identifier data with a first threshold; and to further determine that the apparatus is in the first state if the number of different identifier data is less than the first threshold.

41. The apparatus according to any of the examples 30 to 40, the memory and the computer program code further configured to, with the processor, cause the apparatus to further examine the number of detected changes in identifier data; and to determine that the apparatus is in the first state if the number of detected changes in identifier data is less than a second threshold.

42. The apparatus according to any of the examples 30 to 41, the memory and the computer program code further configured to, with the processor, cause the apparatus to examine the identifier data periodically.

43. The apparatus according to any of the examples 30 to 42, the memory and the computer program code further configured to, with the processor, cause the apparatus to use a certain number of identifiers in the set of identifiers.

44. The apparatus according to the example 43, the memory and the computer program code further configured to, with the processor, cause the apparatus further to insert an identifier in the set of identifiers, and remove another identifier from the set of identifiers.

45. The apparatus according to any of the examples 30 to 44, the memory and the computer program code further configured to, with the processor, cause the apparatus further to use an identifier of an access point of the communication network as the identifier data.

46. The apparatus according to the example 45, wherein the identifier is a cell identifier.

47. The apparatus according to the example 45 or 46, wherein the access point is at least one of the following:
an access point of a wireless local area network;
a base station of a cellular communications network;
a short-range communication device.

48. The apparatus according to any of the examples 30 to 47, the memory and the computer program code further configured to, with the processor, further cause the apparatus to:
use the set of identifier data to determine a current location of the apparatus;
compare the current location with a set of previous location information;
conditionally create a new location information, if the comparison indicates that the current location is a new location.

49. The apparatus according to any of the examples 30 to 48, the memory and the computer program code further configured to, with the processor, cause the apparatus to define a low-power context sensing mode of the apparatus.

50. The apparatus according to the example 49, the memory and the computer program code further configured to, with the processor, cause the apparatus to determine how many times the context has been obtained by analyzing sensor data.

51. The apparatus according to the example 50, the memory and the computer program code further configured to, with the processor, cause the apparatus to use the number of times the context has been obtained to enable or disable the low-power context sensing mode.

52. The apparatus according to the example 49, 50 or 51, the memory and the computer program code further configured to, with the processor, cause the apparatus to gradually increase a frequency of operating in the low-power context sensing mode.

53. The apparatus according to any of the examples 49 to 52, the memory and the computer program code further configured to, with the processor, cause the apparatus to obtain indication of the correctness of the context data, and to use the indication to control the frequency of operating in the low-power context sensing mode.

54. The apparatus according to any of the examples 49 to 53, the memory and the computer program code further configured to, with the processor, cause the apparatus to enable the low-power context sensing mode when an energy level in a battery of the apparatus is below a predetermined value.

55. The apparatus according to any of the examples 49 to 54, the memory and the computer program code further configured to, with the processor, cause the apparatus to adjust the frequency of operating in the low-power context sensing mode based on an energy level in a battery of the apparatus.

56. The apparatus according to any of the examples 49 to 55, the memory and the computer program code further configured to, with the processor, cause the apparatus to disable the low-power context sensing mode when the apparatus is being charged.

57. The apparatus according to any of the examples 49 to 56, the memory and the computer program code further configured to, with the processor, cause the apparatus to manually enable or disable the low-power context sensing mode.

58. The apparatus according to any of the examples 49 to 57, wherein the apparatus comprises a power saving mode, wherein the memory and the computer program code further configured to, with the processor, cause the apparatus to enable the low-power context sensing mode when the power saving mode of the apparatus is on.

59. A computer program comprising program instructions for:
receiving at least one identifier data relating to a communication network;
examining a set of identifier data to identify number of different identifier data in the set of identifier data;
on the basis of the examining determining a status of an apparatus; and
if the examining indicates that the status of the apparatus is a first state, examining context data relating to the first state to determine a current context of the apparatus.

60. The computer program according to the example 59, said program codes further comprising instructions for using the context data to replace context data obtained by analyzing sensor data or using the context data in addition to context data obtained by analyzing sensor data.

61. The computer program according to the example 59 or 60, wherein the context data relating to the first state relates to past contexts.

62. The computer program according to the example 59, 60 or 61, said program codes further comprising instructions for using the set of identifier data to determine a location.

63. The computer program according to the example 62, said program codes further comprising instructions for using a context data relating to the location to determine the current context of the apparatus.

64. The computer program according to any of the examples 59 to 63, wherein the context data comprises at least one of the following:
a histogram of past contexts;
activity data;
environment data.

65. The computer program according to any of the examples 59 to 64, said program codes further comprising instructions for collecting histogram of environments or activities or both.

66. The computer program according to any of the examples 59 to 65, wherein in the first state the apparatus is determined to be static.

67. The computer program according to any of the examples 59 to 66, wherein if the examining indicates that the status of the apparatus is a second state, the apparatus is determined to be in motion.

68. The computer program according to the example 67, wherein if the examining indicates that the status of the apparatus is in motion, said program codes further comprising instructions for examining the set of identifier data to determine a motion path of the apparatus.

69. The computer program according to any of the examples 59 to 68, said program codes further comprising instructions for comparing the number of different identifier data with a first threshold; and for determining that the apparatus is in the first state if the number of different identifier data is less than the first threshold.

70. The computer program according to any of the examples 59 to 69, said program codes further comprising instructions for examining the number of detected changes in identifier data; and for determining that the apparatus is in the first state if the number of detected changes in identifier data is less than a second threshold.

71. The computer program according to any of the examples 59 to 70, said program codes further comprising instructions for examining the identifier data periodically.

72. The computer program according to any of the examples 59 to 71, said program codes further comprising instructions for using a certain number of identifiers in the set of identifiers.

73. The computer program according to the example 72, said program codes further comprising instructions for inserting an identifier in the set of identifiers, and removing another identifier from the set of identifiers.

74. The computer program according to any of the examples 59 to 73, said program codes further comprising instructions for using an identifier of an access point of the communication network as the identifier data.

75. The computer program according to the example 74, wherein the identifier is a cell identifier.

76. The computer program according to the example 74 or 75, wherein the access point is at least one of the following:
an access point of a wireless local area network;
a base station of a cellular communications network;
a short-range communication device.

77. The computer program according to any of the examples 59 to 76, said program codes further comprising instructions for:
using the set of identifier data to determine a current location of the apparatus;
comparing the current location with a set of previous location information;
conditionally creating a new location information, if the comparison indicates that the current location is a new location.

78. The computer program according to any of the examples 59 to 77, said program codes further comprising instructions for defining a low-power context sensing mode of the apparatus.

79. The computer program according to the example 78, further said program codes further comprising instructions for determining how many times the context has been obtained by analyzing sensor data.

80. The computer program according to the example 79, said program codes further comprising instructions for using the number of times the context has been obtained to enable or disable the low-power context sensing mode.

81. The computer program according to the example 78, 79 or 80, said program codes further comprising instructions for gradually increasing a frequency of operating in the low-power context sensing mode.

82. The computer program according to any of the examples 78 to 81, said program codes further comprising instructions for obtaining indication of the correctness of the context data, and using the indication to control the frequency of operating in the low-power context sensing mode.

83. The computer program according to any of the examples 78 to 82, said program codes further comprising instructions for enabling the low-power context sensing mode when an energy level in a battery of the apparatus is below a predetermined value.

84. The computer program according to any of the examples 78 to 83, said program codes further comprising instructions for adjusting the frequency of operating in the low-power context sensing mode based on an energy level in a battery of the apparatus.

85. The computer program according to any of the examples 78 to 84, said program codes further comprising instructions for disabling the low-power context sensing mode when the apparatus is being charged.

86. The computer program according to any of the examples 78 to 85, said program codes further comprising instructions for manually enabling or disabling the low-power context sensing mode.

87. The computer program according to any of the examples 78 to 86, wherein the apparatus comprises a power saving mode, wherein said program codes further comprises instructions for enabling the low-power context sensing mode when the power saving mode of the apparatus is on.

88. The computer program according to any of the examples 59 to 87, wherein the computer program is comprised in a computer readable storage medium.

89. An apparatus comprising:
an input adapted to receive at least one identifier data relating to a communication network;
a first examining element adapted to examine a set of identifier data to identify number of different identifier data in the set of identifier data;
a determinator adapted to determine a status of the apparatus on the basis of the examining; and
a second examining element adapted to examine context data relating to the first state to determine a current context of the apparatus, if the examining indicates that the status of the apparatus is a first state.

90. An apparatus comprising:
means for receiving at least one identifier data relating to a communication network;
means for examining a set of identifier data to identify number of different identifier data in the set of identifier data;
means for determining a status of the apparatus on the basis of the examining; and
means for examining context data relating to the first state to determine a current context of the apparatus, if the examining indicates that the status of the apparatus is a first state.

91. The apparatus according to any of the examples 30 to 58, 89 or 90, wherein the apparatus is a wireless communication device.

1-91. (canceled)

92. A method comprising:
receiving at least one identifier data relating to a communication network;
examining a set of identifier data to identify number of different identifier data in the set of identifier data;
on the basis of the examining determining a status of an apparatus; and
if the examining indicates that the status of the apparatus is a first state, examining context data relating to the first state to determine a current context of the apparatus.

93. The method according to claim 92, comprising using the context data to replace context data obtained by analyzing sensor data or using the context data in addition to context data obtained by analyzing sensor data.

94. The method according to claim 92, wherein the context data relating to the first state relates to past contexts.

95. The method according to claim 92, further comprising comparing the number of different identifier data with a first threshold; and determining that the apparatus is in the first state if the number of different identifier data is less than the first threshold.

96. The method according to claim 92, further comprising examining the number of detected changes in identifier data; and determining that the apparatus is in the first state if the number of detected changes in identifier data is less than a second threshold.

97. The method according to claim 92, further comprising:
using the set of identifier data to determine a current location of the apparatus;
comparing the current location with a set of previous location information;
conditionally creating a new location information, if the comparison indicates that the current location is a new location.

98. The method according to claim 92, comprising:
defining a low-power context sensing mode of the apparatus; and
determining how many times the context has been obtained by analyzing sensor data.

99. The method according to claim 98, further comprising adjusting the frequency of operating in the low-power context sensing mode based on an energy level in a battery of the apparatus.

100. The method according to claim 98, wherein the apparatus comprises a power saving mode, wherein the method comprises enabling the low-power context sensing mode when the power saving mode of the apparatus is on.

101. An apparatus comprising a processor and a memory including computer program code, the memory and the computer program code configured to, with the processor, cause the apparatus:
to receive at least one identifier data relating to a communication network;
to examine a set of identifier data to identify number of different identifier data in the set of identifier data;
on the basis of the examining to determine a status of the apparatus; and
if the examining indicates that the status of the apparatus is a first state, to examine context data relating to the first state to determine a current context of the apparatus.

102. The apparatus according to claim 101, the memory and the computer program code configured to, with the processor, cause the apparatus to use the context data to replace context data obtained by analyzing sensor data or using the context data in addition to context data obtained by analyzing sensor data.

103. The apparatus according to claim 101, wherein the context data relating to the first state relates to past contexts.

104. The apparatus according to claim 101, the memory and the computer program code further configured to, with the processor, cause the apparatus to compare the number of different identifier data with a first threshold; and to further determine that the apparatus is in the first state if the number of different identifier data is less than the first threshold.

105. The apparatus according to claim 101, the memory and the computer program code further configured to, with the processor, cause the apparatus to further examine the number of detected changes in identifier data; and to determine that the apparatus is in the first state if the number of detected changes in identifier data is less than a second threshold.

106. The apparatus according to claim 101, the memory and the computer program code further configured to, with the processor, further cause the apparatus to:
use the set of identifier data to determine a current location of the apparatus;
compare the current location with a set of previous location information;
conditionally create a new location information, if the comparison indicates that the current location is a new location.

107. The apparatus according to claim 101, the memory and the computer program code further configured to, with the processor, cause the apparatus to:
define a low-power context sensing mode of the apparatus; and
determine how many times the context has been obtained by analyzing sensor data.

108. The apparatus according to claim 107, the memory and the computer program code further configured to, with the processor, cause the apparatus to adjust the frequency of operating in the low-power context sensing mode based on an energy level in a battery of the apparatus.

109. The apparatus according to claim 107, wherein the apparatus comprises a power saving mode, wherein the memory and the computer program code further configured to, with the processor, cause the apparatus to enable the low-power context sensing mode when the power saving mode of the apparatus is on.

110. A computer comprising program instructions for:
receiving at least one identifier data relating to a communication network;
examining a set of identifier data to identify number of different identifier data in the set of identifier data;
on the basis of the examining determining a status of an apparatus; and
if the examining indicates that the status of the apparatus is a first state, examining context data relating to the first state to determine a current context of the apparatus.

111. The computer program according to claim 110, said program codes further comprising instructions for:
defining a low-power context sensing mode of the apparatus; and
determining how many times the context has been obtained by analyzing sensor data.
